(19) United States
(12) Patent Application Publication
(10) Pub. No.: US 2004/0095297 A1
(43) Pub. Date: May 20, 2004

(54) Nonlinear voltage controlled current source with feedback circuit

(75) Inventors: Frank R. Libsch, White Plains, NY (US); James L. Sanford, Hopewell Junction, NY (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: International Business Machines Corporation

(21) Appl. No.: 10/300,640

(22) Filed: Nov. 20, 2002

(51) Int. Cl. G09G 3/30

(52) U.S. Cl. 345/76

(57) ABSTRACT

A light emitting pixel circuit comprising a light emitting diode having a parasitic capacitance and coupled to a current source; nonlinear feedback means for rapidly charging the parasitic capacitance and for enabling immediately following such charging, illumination of the diode, responsive to a predefined constant current level from the current source.

### FIELD OF THE INVENTION

The present invention relates to light emitting diode displays and to particular types of diodes useful for such displays, known as organic light emitting diodes OLED and a variation thereof; i.e., known as AMOLED, the AM standing for active matrix.

### BACKGROUND OF THE INVENTION

Unlike liquid crystal displays (LCDs), there are several unique issues associated with active matrix organic light emitting diode (AMOLED) displays. These issues must be taken into account to drive AMOLED displays optimally. These unique issues are:

1) The OLED's high parasitic capacitance, on the order of 6 pF per pixel, must be charged (along with any line capacitance) before illumination can follow;

2) the OLED is a current mode device such that the gray scale illumination is proportional to current flowing through the OLED, with current accuracy and matching of 1% or less desired, and

3) the thin film transistor (TFT) semiconductor technologies used today for active matrix displays, such as a morphous silicon ( a-Si), poly-silicon (poly-Si), organic (such as pentacene) and Cadmiun Selenium (CdSe), would be required to operate at a substantially higher percentage on time (higher duty cycle), from 0.1% for a typical AMLCD XGA display today, to the range of 10 to 100%.

In addition, when constant current drive is employed, it is most difficult to operate with the lowest levels of OLED illumination, which require the lower levels of constant current and hence require longer parasitic capacitance chargeup times, current being inversely proportional to the chargeup time.

Like other flat panel displays such as those having LCDs, AMOLED displays also exhibit some common undesirable issues, such as the fact that thin film transistor (TFT) technologies used today for active matrix displays all exhibit device degradation, with one of the main components being transistor threshold voltage shift with operation time.

Accordingly, a primary object of the present invention is to enable quick charging of the high parasitic capacitance associated with the above described diodes, and immediately provide the steady state current needed in the pixel circuit.

### SUMMARY OF THE INVENTION

A broad feature of the present invention resides in the provision, in a pixel circuit, of a voltage controlled current source using nonlinear feedback for rapidly charging parasitic capacitance. In addition, the current feedback arrangement, by dint of a suitably provided current sense means, will not only automatically provide the nonlinear current flow (versus constant) for charging up the parasitic capacitance quickly, but will also immediately produce, after the capacitance charging takes place, a steady state (constant current) with minimum ringing to a predefined desired current level, thereby enabling proper light emission.

Most significantly, this predefined current level is proportional to the threshold voltage of the thin film transistor (TFT) being monitored, and will thus adjust to the new threshold voltage value brought on by TFT aging. Such architecture and technique is extremely useful for driving OLEDs, where the relatively large (approximately 6 pF/pixel) turn-on parasitic capacitance needs to be charged before on current flow for rumination takes place, and where increasing duty cycle (greater than 50% range) is expected to cause instabilities resulting in TFT threshold voltage shifts. This architecture is well suited for implementation into OLED data current driver chips or integrated driver circuitry.

The foregoing and still further objects and advantages of the present invention will be more apparent from the following detailed explanation of the preferred embodiments of the invention in connection with the accompanying drawing.

### BRIEF DESCRIPTION OF THE DRAWINGS

FIG. 1 is a block diagram of the scheme of meeting the described issues and/or problems present as certain light emitting diode displays;

FIG. 2 is a more detailed schematic diagram of an implementation of the system of FIG. 1;

FIG. 3 is a graph defining VT′ in relationship to the linear extrapolated value of VT′ where VT′ is the value of V_{OUT} shown in the circuit of FIG. 2;

FIG. 4 is a graph of V_{OUT} versus time (t); and

FIGS. 5A, 5B, 6A and 6B are various graphs of current charging times.

### DESCRIPTION OF PREFERRED EMBODIMENTS

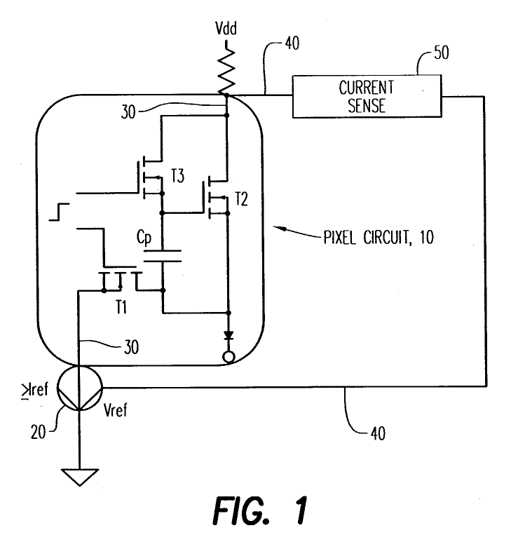

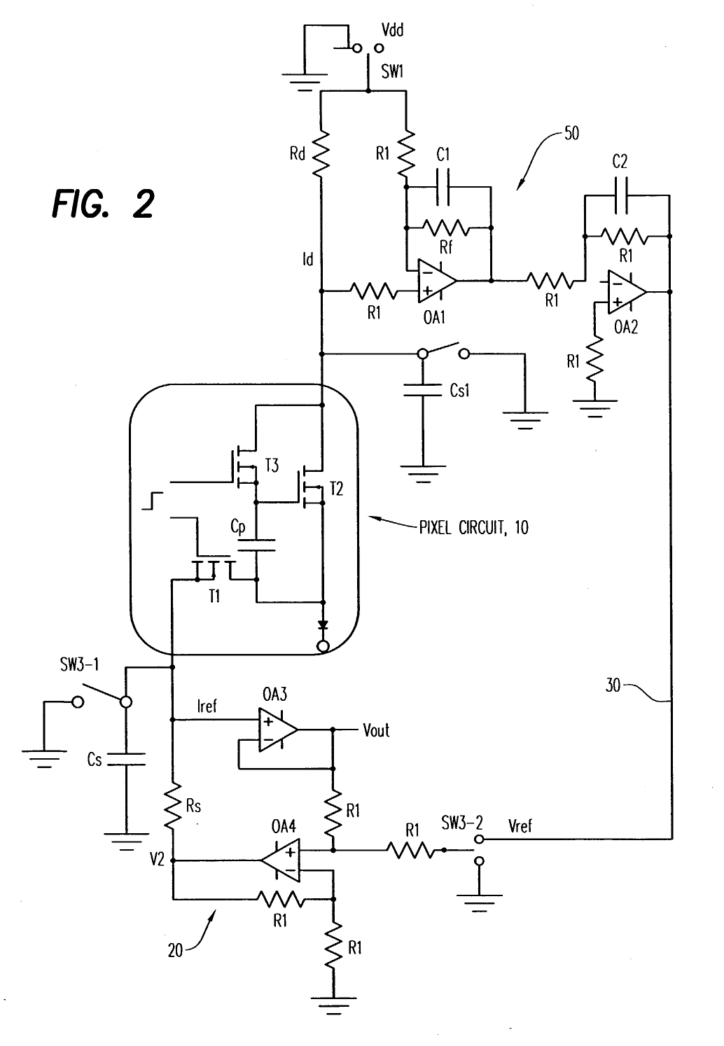

Referring now to the figures of the drawing, the block diagram of the disclosed architecture capable of meeting the issues discussed above is shown in FIG. 1, with an equivalent detailed circuit implementation shown in FIG. 2. In this architecture, an OLED pixel illumination mode would require a constant gate voltage on the driver TFT T1, such as, but not limited to ground, and the source voltage adjusts to a value so that Vgs supports a predetermined current value. The “threshold voltage” defined by this predetermined current value is negative of the source voltage. The current source 20 is intended to provide a high output impedance and bi-directional current. The feedback settling time and the charging of the parasitic capacitance (mainly associated with the data line 30), account for a finite but small delay. The current source and/or the current feedback 40 can be implemented in the pixel or in the peripheral circuitry of the array, including but not limited to the display data current driver chips.

FIG. 2 shows one possible circuit implementation from the architecture disclosed in FIG. 1, that can be implemented in the data current drivers. When the pixel is in the inactive (no current) state, all switches—SW1, SW3-1 and SW3-2—are set to the ground pole, including the pixel TFTs T1 and T3. When the pixel is in the illumination mode with the feedback circuit employed, all switches are set to the pole other than ground, including the pixel TFT T3, with the gates high (N-channel). Note that TFT T1 gate remains grounded since the feedback circuit dynamic range covers both positive and negative, and hence TFT T1 will be turned on by having the source pulled negative to a voltage that will support the constant current.

The current source is formed by operational amplifiers 3 and 4 which operate as well to provide a unity gain buffer for the source of the OLED under illumination. Opamp 1 and 2 constitute a current sense amplifier 50 and are used as a proportional feedback element for the current source voltage reference Vref. The current source 20 senses the threshold at a predefined current level. The feedback increases the current source output current, for zero drain voltage, for example, by a factor of 10 or more; this is in order to facilitate the charging of parasitic and stray capacitances at the data line 30 and the pixel 10, before the appropriate current reference I_{REF} is established through T1 and T2.

Also note that the feedback arrangement ensures that the current through T1 and T2 is monotonically increasing up to the appropriate current reference level. As the parasitic capacitance C_{S} and C1 charges up, the current source current decrease so as to minimize any voltage overshoot across the gate-to-source of T1. The current source current decreases by a factor related to [1+R_{D}/R_{S} (1+R_{F}/R₁)]. The value of the current source is related to Vref by Iref=Vref/Rs. At t=0, Vref=−Vdd. For example, for values of Vdd=5V, Rs=50 KOhms, R_{F}/R₁=10, and R_{D}/R_{S}=1, I_{ref}=Vdd/R_{S}=5V/50 kOhm, or 100 uA at t=0 and I_{ref}=[1+R_{D}/R_{S}(1+R_{F}/R₁)]⁻¹ Vdd/R_{S}=[1/12] 5V/50 kOhm, or 8.33 uA at steady state times (t>t₀). All Opamps 1-4 operate in the linear region so that no unnecessary saturation delays and unwarranted stressing result.

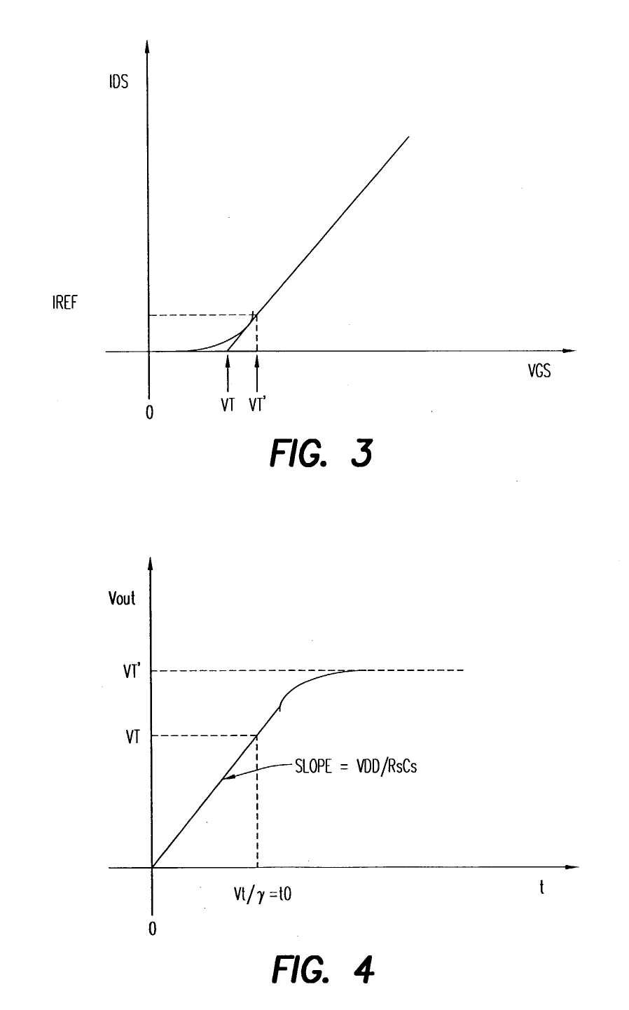

The transient analysis of the circuit in FIG. 2, assume an n-channel transistor (T1) and the gate to source voltage V_{T} (which supports a fixed drain current I^{REF}) is more positive than the classical, linear region line extrapolated, threshold voltage VT′, as shown in the graph of FIG. 3. A positive is being considered. For simplification, the time constants corresponding to the compensating capacitors on the various Opamps have been neglected, and that the Opamps are of high slew rate (greater than 500 V/us) and wide bandwidth (greater than 70 MHz), such as the ADLH0032G. A typical Opamp that has been in existence for more than 20 years, is the ADLH0032G with a slew rate greater than 500 V/us and a greater than 70 MHz bandwidth. It is possible to obtain higher slew rate and bandwidth Opamps today.

The charging equation is

$${C}_{s} \frac{ⅆ {V}_{out}}{ⅆ t} = {I}_{REF} - {I}_{D} .$$

For an initial condition of Vₒᵤₜ=0, where V_{OUT}<lV_{Tl}, or where T2 is off, we have I_{D}<<I_{REF} and leads to the relation

$${V}_{OUT} = + \frac{{V}_{DD} t}{{R}_{S} {C}_{s}} .$$

Consider the region for V_{OUT}νV_{T}. For the transistor, T2, operating in the saturated state, the differential equation can be written as

$$\frac{\neq {V}_{OUT}}{\neq t} = \frac{{V}_{DD}}{{R}_{S} {C}_{S}} + \frac{β}{2 {C}_{S}} {( {V}_{OUT} + {V}_{T} )}^{2} \{ \frac{{R}_{D}}{{R}_{S}} ( 1 + \frac{{R}_{F}}{R1} ) + 1 \} ,$$

where C_{S} is the parasitic capacitance, including the data line and pixel parasitic capacitance, that the driver TFT, T2, must charge, and β is the TFT device transconductance parameter equal to μₙCᵢₙW/L , which is the product of TFT channel mobility, gate insulator capacitance, width and length of the channel. The other resistances and voltages are defined in FIG. 2.

Through substitution of V [symbol] _{OUT}=V_{OUT}+V_{T},

and

$$χ = \frac{{V}_{DD}}{{R}_{s} {C}_{s}}$$

and

$$α = \frac{β}{2 {C}_{s}} \{ \frac{{R}_{D}}{{R}_{S}} ( 1 + \frac{{R}_{F}}{{R}_{1}} ) + 1 \}$$

We obtain

$$\frac{{dV}_{out}^{}}{{V}_{OUT}^{{2}_{}} + χ / α} = α d t$$

Use the initial condition that V [symbol] _{OUT}=0 at t=t₀, where t₀ is given by

$${t}_{0} = \frac{{V}_{T} {R}_{S} {C}_{S}}{{V}_{DD}} .$$

For time t>t₀, the solution of the feedback system is proportional to the TFT threshold voltage, V_{T}, or

$${V}_{OUT} = - {V}_{T} + \sqrt{\frac{χ}{α}} [ 1 - \frac{2}{exp \{ 2 \sqrt{α χ} ( t - \frac{{V}_{T}}{χ} \} + 1} ]$$

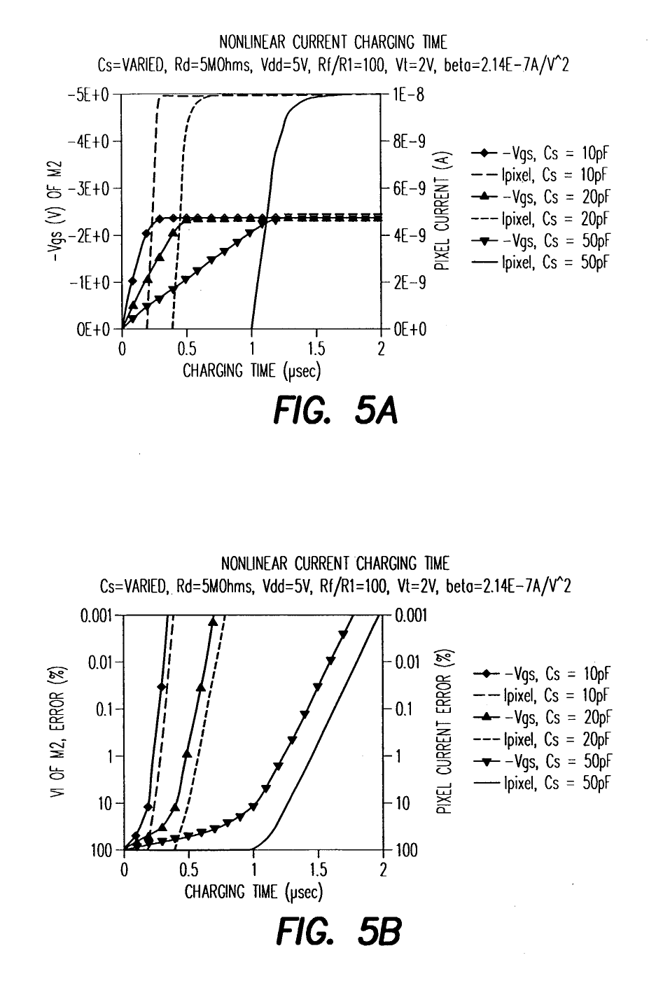

The graphical representation is shown in FIG. 4.

The method is capable of meeting several AMOLED specifications, namely:

1.) 6-bit to 8-bit accurate gray levels

2.) Independent gray level control for each color

3.) Precharge Cp to approximately T2 threshold voltage.

4.) Selectable current magnitude range from 10 nA to 100 uA per column with 6-bit to 8-bit control (100/64% to 100/256% accuracy)

5.) Output matching (Cp charging to T2 threshold voltage) to 1% adequate

6.) Row time current source settling.

For example, letting Vdd=5V, Rs=50 KOhms, and the parasitic data line capacitance being 10 pF gives a charging time, γ, of 10 V/usec. This slew rate insures that the internal Opamp slew rates are higher, and that the feedback will respond quicker than the charging of the data line capacitance. To reach a T2 threshold voltage, Vt, of 5V would take approximately 500 nsec, where t0=500 nsec. For larger displays exhibiting larger data line capacitance, Rs can be reduced proportionally, with the lower limit being approximately the output resistance of the current driver, or for today's drivers, a reasonable output resistance of today's current data driver is approximately 2 Kohm per output

A number of approaches have been made in solving the problem discussed here. For example, one approach (Clare Micronix) uses a column driver chip and circuit therein for reserving a constant time portion of the scan cycle to precharge the columns to a voltage threshold that is just below the onset of conduction. During a second time portion, the driver circuit applies a precision, but constant on current that is pulse width modulated to give an integrated current density proportional to the desired OLED light output.

The disclosed approach differs substantially and has the advantages of (1) uses only one time portion (verus two), (2) using a nonlinear (versus constant) current amplitude, and (3) using current amplitude modulation (versus pulse width modulation). The advantages of (1), or of using only one time portion is that there is more time available for OLED luminance, and since the output luminance is proportional to the integrated current density over the frame cycle, a lower amplitude current is needed to achieve the same integrated current density. The OLED is more power efficient operating at lower current density. The advantage of (2), or using a nonlinear current amplitude is that precharge time is minimized and independent of colors. The data line capacitance to the pixel will vary dependent on the pixel location from the data current driver source, so minimizing the data line parasitic charging leaves more time for pixel capacitance charging, resulting in more accuracy. The advantage of (3), of using current amplitude modulation is that the entire scan time is available for OLED luminance, and as stated above, since the output luminance is proportional to the integrated current density over the frame cycle, a lower amplitude current is needed to achieve the same integrated current density, thus providing a more power efficient drive method.

Table 1 shows the range of the nonlinear current source pixel feedback circuit for various parameters. The dependency of the parameter on the final pixel current, Ipixel, and charging time, t@0.999 Ipixel(t=α), as a dependency on the parameters can be obtained by comparing the different rows. This is only an example for illustrative purposes, where optimization has not been performed. For example, data rows 3 through 6 (blue) correspond to three orders of magnitude in pixel current, (Ipixzel from 10 nA to 10 uA) and the corresponding charging time to achieve 0.999 of the targeted pixel current (t@0.999 Ipixel(t=α) from 9.99 nA to 9.99 uA), or 0.1% error, which ranges from 0.6 usec to 0.9 usec. Rows 7 through 10 (green) correspond to the four rows 3 through 6 (blue) with the threshold voltage of M2 in the pixel now shifted by 5V, from a Vt of 2V to a V5 of 7V, which now ranges from a charging time of 1.0 usec to 1.6 usec. If an even faster charging time is desired, Vdd may be increased, for example from 5V to 10V. Rows 13 through 16 correspond to the earlier rows 7, 10, 3, 6, respectively, where the charging time is now decreased to the range from 0.4 usec to 0.9 usec. −Vgs and Vdd signifies the negative and positive-most voltages in the circuit. Note that only Vdd needs to be set externally since −Vgs is the negative of the Vgs of M2 needed to sustain the targeted pixel current, where the gate voltage is ground. The parameters where chosen such that Rd was inversely log proportional to the targeted pixel; current and Rs was inversely log proportional to the reference current, Iref. In order to insure adequate short charging times, Iref was chosen at least two orders of magnitude greater than the targeted pixel current. Also not from the following Figs. that the targeted pixel current error decreases linearly and exponentially as a function of charging times less than and greater than the pixel TFT M2 turnon time constant, τₒ, respectively. Also note from the Figs. that there is no overshoot to pixel current.

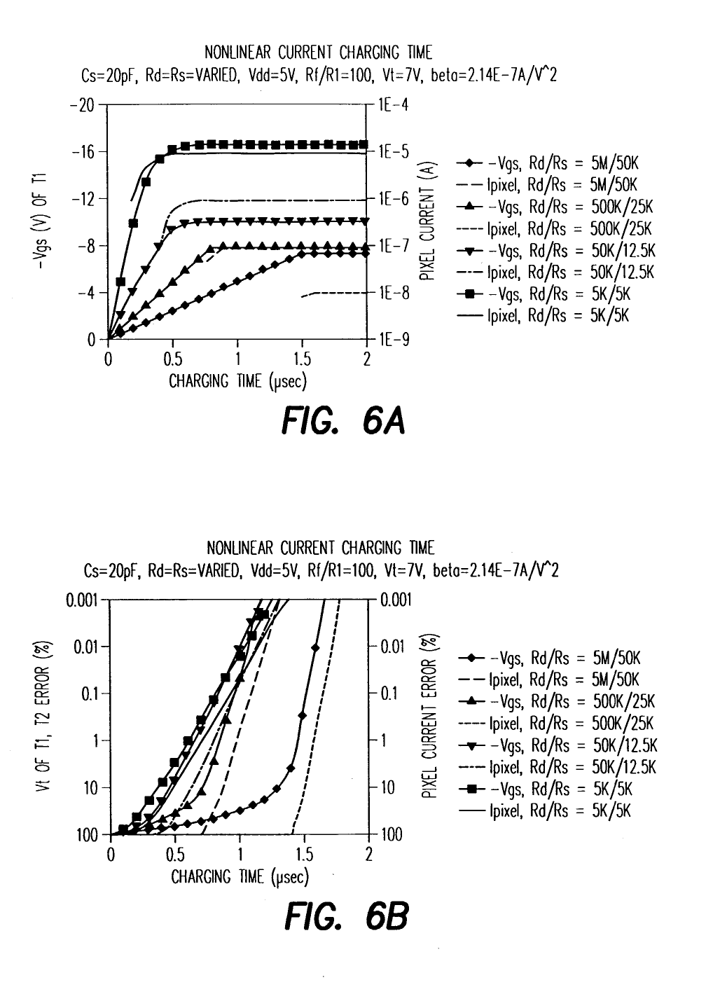

FIG. 5a and 5b show the dependency of the line capacitance over a range of 10 pF to 50 pF on the charge up time verus the pixel current and pixel voltage reference error, respectively. The three set of curves correspond to rows 1 through 3 of Table 1. FIG. 6a and 6b show the dependency of the pixel current over a range of 10 nA to 10 uA on the charge up time verus the pixel current and pixel voltage reference error, respectively, for a situation after a 5V TFT threshold voltage shift. The four sets of curves correspond to rows; 7 through 10 of Table 1.

TABLE I
Nonlinear Current Source Pixel Feedback
(Sets of examples and data)

| | | | | | | −Vgs of | | | | | T@0.99 | T@0.999 | Pixel TFT M2 | |
|---|---|---|---|---|---|---|---|---|---|---|---|---|---|---|
| | Cs | Rs | Rd | Vt of M2 | Vdd | M2 | Iref | | Ipixel | | Ipixel | Ipixel | Turn on Time | |
| Row | (pF) | (Ohms) | (Ohms) | (V) | (V) | (V) | (t = 0) | | (t = α) | | (t = α) | (t = α) | Constant τ0 | |
| 1 | 10 | 50K | 5 M | 2 | 5 | −2.3 | 100 | uA | 10 | nA | 0.3 usec | 0.4 usec | 0.2 | usec |
| 2 | 50 | 50K | 5 M | 2 | 5 | −2.3 | 100 | uA | 10 | nA | 1.5 usec | 1.6 usec | 1.0 | usec |
| 3 | 20 | 50K | 5 M | 2 | 5 | −2.3 | 100 | uA | 10 | nA | 0.6 usec | 0.7 usec | 0.4 | usec |
| 4 | 20 | 25K | 500K | 2 | 5 | −2.96 | 200 | uA | 100 | nA | 0.5 usec | 0.6 usec | 0.2 | usec |
| 5 | 20 | 12.5K | 50K | 2 | 5 | −5.05 | 400 | uA | 1 | uA | 0.6 usec | 0.8 usec | 0.1 | usec |
| 6 | 20 | 5K | 5K | 2 | 5 | −11.67 | 1 | mA | 10 | uA | 0.6 usec | 0.9 usec | 0.04 | usec |
| 7 | 20 | 50K | 5 M | 7 | 5 | −7.3 | 100 | uA | 10 | nA | 1.6 usec | 1.6 usec | 1.4 | usec |
| 8 | 20 | 25K | 500K | 7 | 5 | −7.96 | 200 | uA | 100 | nA | 1.0 usec | 1.1 usec | 0.7 | usec |
| 9 | 20 | 12.5K | 50K | 7 | 5 | −10.05 | 400 | uA | 1 | uA | 0.8 usec | 1.0 usec | 0.35 | usec |
| 10 | 20 | 5K | 5K | 7 | 5 | −16.67 | 1 | mA | 10 | uA | 0.8 usec | 1.0 usec | 0.14 | usec |
| 11 | 20 | 50K | 5 M | 7 | 10 | −7.43 | 200 | uA | 20 | nA | 0.8 usec | 0.9 usec | 0.7 | usec |
| 12 | 20 | 5K | 5K | 7 | 10 | −20.68 | 2 | mA | 20 | uA | 0.5 usec | 0.6 usec | 0.07 | usec |
| 13 | 20 | 50K | 10 M | 7 | 10 | −7.3 | 200 | uA | 10 | nA | 0.8 usec | 0.9 usec | 0.7 | usec |
| 14 | 20 | 5K | 10K | 7 | 10 | −16.65 | 2 | mA | 10 | uA | 0.4 usec | 0.5 usec | 0.07 | usec |
| 15 | 20 | 50K | 10 M | 2 | 10 | −2.3 | 200 | uA | 10 | nA | 0.3 usec | 0.4 usec | 0.2 | usec |
| 16 | 20 | 5K | 10K | 2 | 10 | −11.65 | 2 | mA | 10 | uA | 0.3 usec | 0.4 usec | 0.02 | usec |

Rf = 100K Ohms, R1 = 1K Ohms, Total Feedback Amplifier Gain = 100

The invention having been thus described with particular reference to the preferred forms thereof, it will be obvious that various changes and modifications may be made therein without departing from the spirit and scope of the invention as defined in the appended claims.

What is claimed is

1. A light emitting pixel circuit comprising a light emitting diode having a parasitic capacitance and coupled to a current source; nonlinear feedback means for rapidly charging the parasitic capacitance and for enabling, immediately following such charging, illumination of the diode responsive to a predefined constant current level from the current source.

2. A light emitting pixel circuit wherein said current source is voltage controlled by operation of the feedback means.

3. A light emitting pixel circuit including means for controlling the charging time.

4. A light emitting pixel circuit, wherein the feedback means include current sense means.

5. A light emitting pixel circuit as defined in claim 4, wherein the current sense means includes two interconnected operational amplifiers.

6. A light emitting pixel circuit as defined in claim 5, wherein the current source includes two interconnected operational amplifiers.
